(19) United States
(12) Patent Application Publication
(10) Pub. No.: US 2016/0373403 A1
(43) Pub. Date: Dec. 22, 2016

(54) Electronic Message Tracking Beacon Remediation

(71) Applicant: One More Company Inc., New York, NY (US)

(72) Inventors: Nitsan Seniak, Paris (FR); Florian Seroussi, New York, NY (US)

(21) Appl. No.: 15/188,820

(22) Filed: Jun. 21, 2016

Related U.S. Application Data
(60) Provisional application No. 62/337,831, filed on May 17, 2016.
(60) Provisional application No. 62/183,098, filed on Jun. 22, 2015.

(51) Int. Cl. H04L 12/58; H04L 29/06; G06F 17/30; H04L 29/08

(52) U.S. Cl. CPC H04L 51/34; H04L 67/306; H04L 67/20; H04L 63/1425; G06F 17/30345

(57) ABSTRACT

A method, performed at a server system, includes accessing an electronic message having a message body and received at an account of a respective user. Typically, prior to a first time the respective user views the message body, the electronic message is moved from a first folder of the account of the respective user to a second folder. If the message body includes tracking content, the method includes: generating a modified electronic message having a message body that does not include the tracking content; and storing the modified electronic message in the first folder of the account of the respective user. The modified electronic message that does not include the tracking content is provided to the respective user, at a respective client system, in response to a request for the electronic message, wherein the server system is distinct from the respective client system.

### RELATED APPLICATIONS

This application claims priority to U.S. Provisional Patent Application No. 62/337,831, filed May 17, 2016, and U.S. Provisional Patent Application No. 62/183,098, filed Jun. 22, 2015, both of which are incorporated by reference herein in their entireties.

### TECHNICAL FIELD

The disclosed embodiments relate generally to electronic messaging server systems and electronic messaging clients (e.g., email server systems and email clients) and the processing of electronic messages prior to or concurrently with their delivery to respective clients.

### BACKGROUND

Electronic messages from a sender to a message recipient sometimes contain tracking content allowing either the sender or a third-party to be informed that the message recipient has opened the electronic message or that the message recipient has accessed content included or linked to in the electronic message. Therefore, it would be desirable to have a system and method of remediating tracking content in electronic messages. It would also be desirable to have a system and method of augmenting an electronic message to include supplemental information, including supplemental information related to the sender of the electronic message.

### SUMMARY

In accordance with some embodiments, a method of processing electronic messages is performed at a server system. The method includes: accessing an electronic message having a message body and received at an account of a respective user; prior to a first time the respective user views the message body, moving the electronic message from a first folder of the account of the respective user to a second folder; and inspecting the message body to determine whether the message body includes tracking content. In accordance with a determination that the message body includes tracking content, the method includes: generating a modified electronic message having a message body that does not include the tracking content; and storing the modified electronic message in the first folder of the account of the respective user; wherein the modified electronic message that does not include the tracking content is provided to the respective user, at a respective client system, in response to a request for the electronic message, wherein the server system is distinct from the respective client system. In accordance with a determination that the message body fails to satisfy predefined criteria, the method includes returning the electronic message from the second folder to the first folder; wherein the electronic message is provided to the respective user in response to a request for the electronic message.

In accordance with some embodiments, a server system includes one or more processors, memory, and one or more programs stored in the memory. The one or more programs include instructions that when executed by the one or more processors of the server system cause the server system to perform or cause performance of the operations of any of the methods described herein.

In accordance with some embodiments, a non-transitory computer readable storage medium stores one or more programs. The one or more programs are configured for execution by a server system having one or more processors for executing the one or more programs. The one or more programs include instructions for performing or causing performance of any of the operations of any of the methods described herein.

In accordance with some embodiments, a method is performed at a server system. The method includes: accessing an electronic message having a message body and received at an account of a respective user; prior to a first time the respective user views the message body, moving the electronic message from a first folder of the account of the respective user to a second folder; and inspecting the electronic message to determine whether the electronic message satisfies predefined criteria. In accordance with a determination that the electronic message satisfies the predefined criteria, the method includes: generating a modified electronic message that includes the received electronic message and supplemental information related to one or more characteristics of the received electronic message; and storing the modified electronic message in the first folder of the account of the respective user; wherein the modified electronic message that includes the supplemental information is provided to the respective user, at a respective client system, in response to a request for the electronic message, wherein the respective client system is distinct from the server system. In accordance with a determination that the electronic message fails to satisfy predefined criteria, the method includes returning the electronic message from the second folder to the first folder; wherein-the electronic message is provided to the respective user in response to a request for the electronic message.

In accordance with some embodiments, a server system includes one or more processors, memory, and one or more programs stored in the memory. The one or more programs include instructions that when executed by the one or more processors of the server system cause the server system to perform or cause performance of the operations of any of the methods described herein.

In accordance with some embodiments, a non-transitory computer readable storage medium stores one or more programs. The one or more programs are configured for execution by a server system having one or more processors for executing the one or more programs. The one or more programs include instructions for performing or causing performance of any of the operations of the methods described herein.

### BRIEF DESCRIPTION OF THE DRAWINGS

FIG. 1 is a block diagram illustrating an implementation of a network system, in accordance with some embodiments.

FIG. 2A is a block diagram illustrating a modification server of a network system, in accordance with some embodiments.

FIG. 2B is a block diagram illustrating a host server of a network system, in accordance with some embodiments.

FIG. 3A illustrates a conceptual flowchart representation of a method of message modification, in accordance with some embodiments.

FIG. 3B illustrates a conceptual flowchart representation of a method of message modification with respect to tracking remediation, in accordance with some embodiments.

FIG. 3C illustrates a conceptual flowchart representation of a method of message modification with respect to message augmentation, in accordance with some embodiments.

FIGS. 4A and 4B illustrate an implementation of an electronic message before message modification and after message modification, respectively.

FIGS. 5A-5D illustrate a flowchart representation of a method of tracking remediation, in accordance with some embodiments.

FIGS. 6A-6C illustrate a flowchart representation of a method of message augmentation, in accordance with some embodiments.

Like reference numerals refer to corresponding parts throughout the drawings.

### DESCRIPTION OF EMBODIMENTS

The various implementations described herein include systems, methods, and/or devices used to enable electronic message tracking beacon remediation and/or electronic message scanning and augmentation.

It will also be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, without changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

As used herein, the phrase “at least one of A, B and C” is to be construed to require one or more of the listed items, and this phase reads on a single instance of A alone, a single instance of B alone, or a single instance of C alone, while also encompassing combinations of the listed items such as “one or more of A and one or more of B without any of C,” and the like.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Reference will now be made in detail to various embodiments, examples of which are illustrated in the accompanying drawings. In the following detailed description, numerous specific details are set forth in order to provide a thorough understanding of the invention and the described embodiments. However, the invention may be practiced without these specific details. In other instances, well-known methods, procedures, components, and circuits have not been described in detail so as not to unnecessarily obscure aspects of the embodiments.

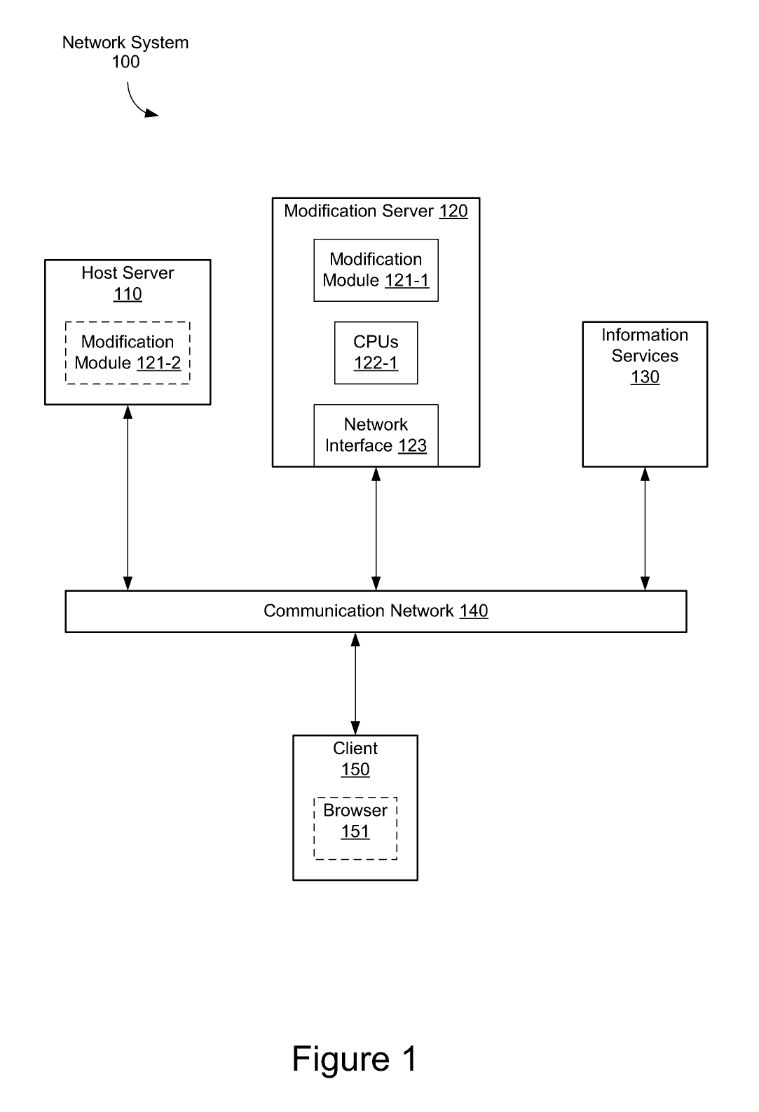

FIG. 1 is a block diagram illustrating an implementation of a network system 100, in accordance with some embodiments. The network system 100 includes a host server 110, a modification server 120, information services 130, a communication network 140, and one or more clients 150. Host server 110, modification server 120, information services 130, and client 150 are connected through communication network 140.

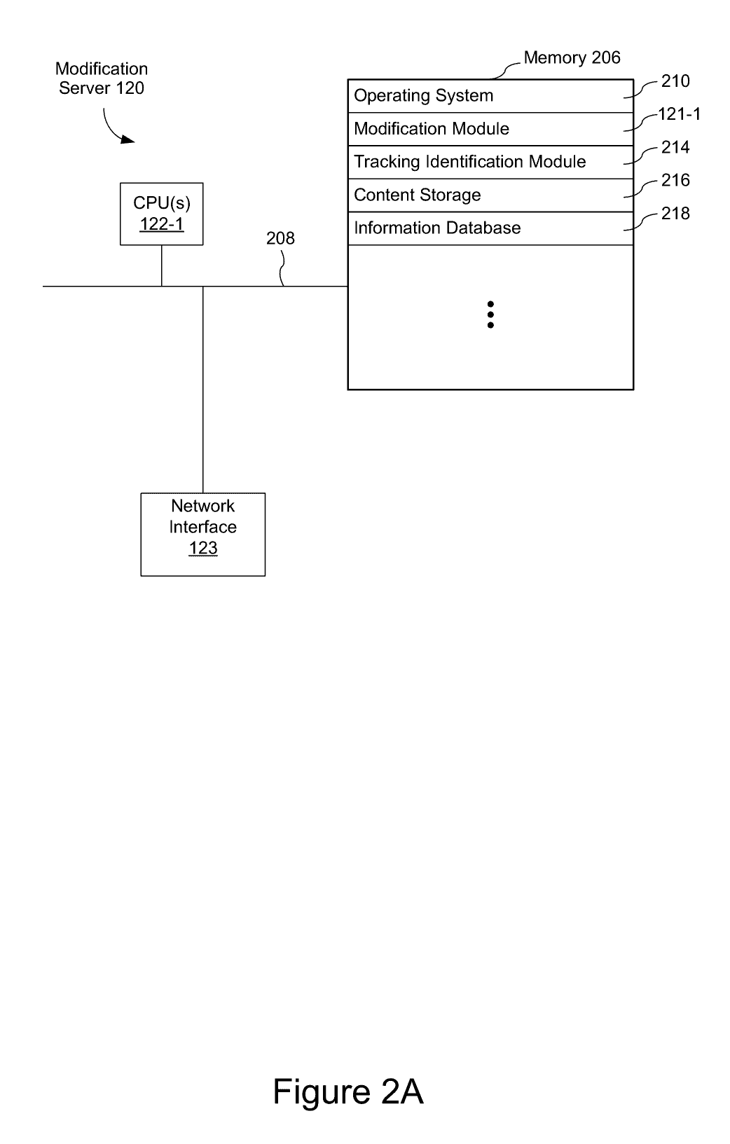

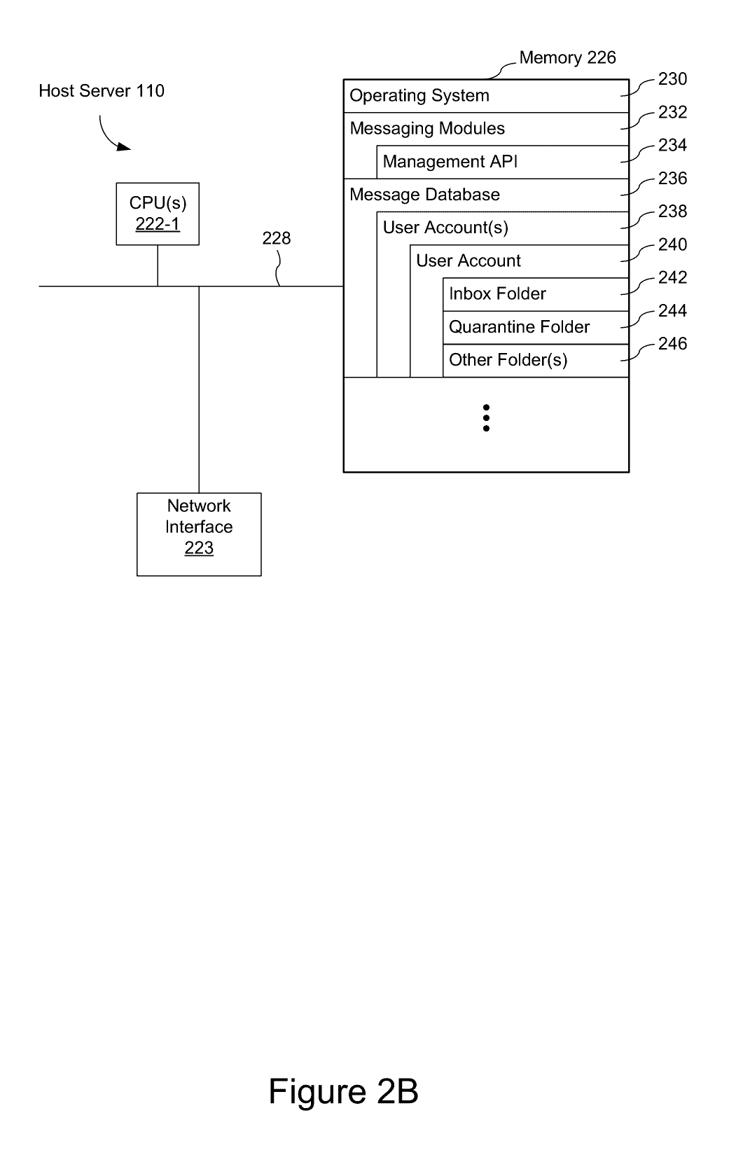

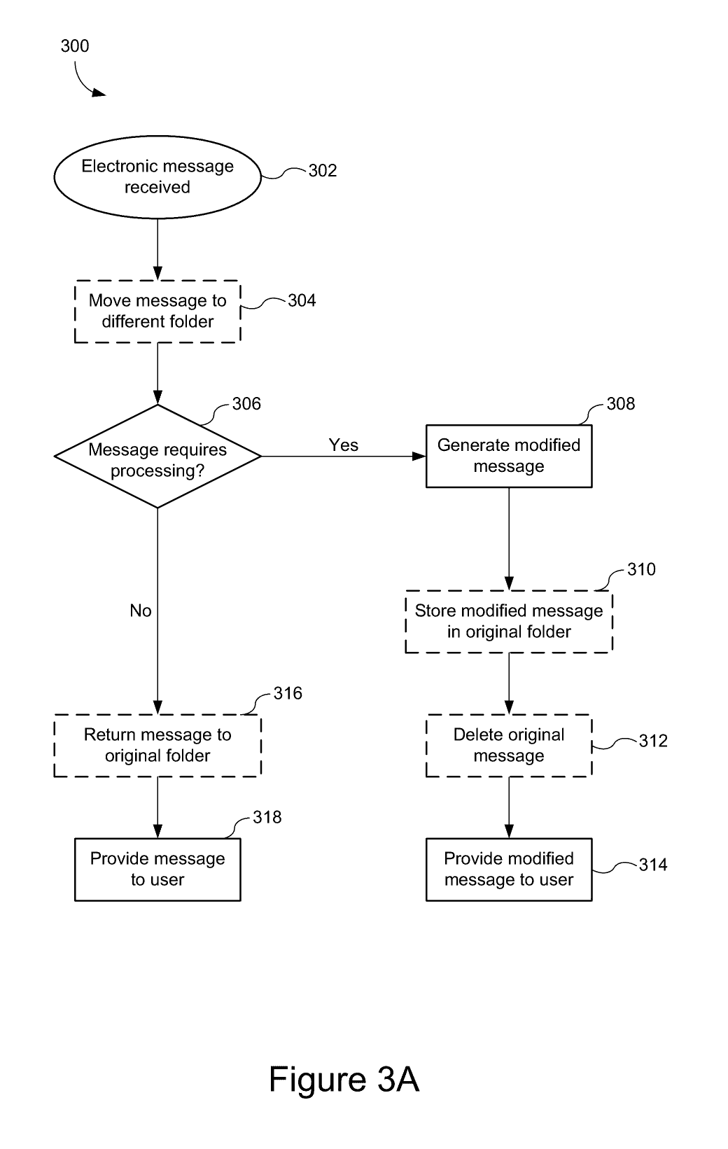

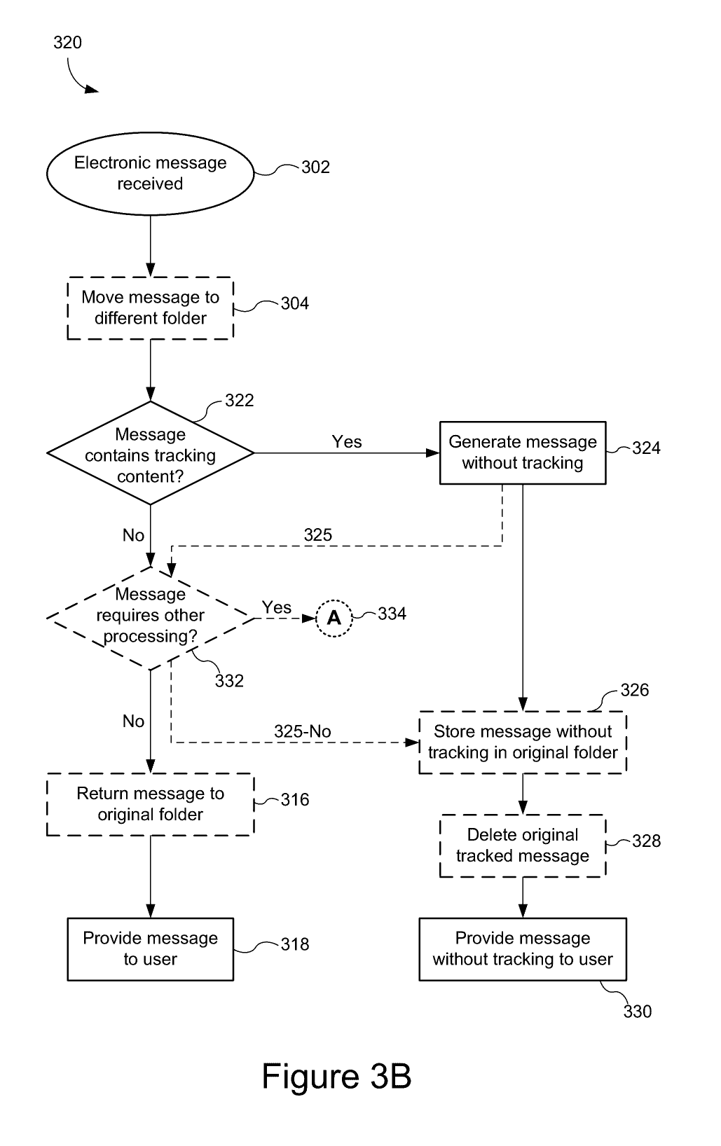

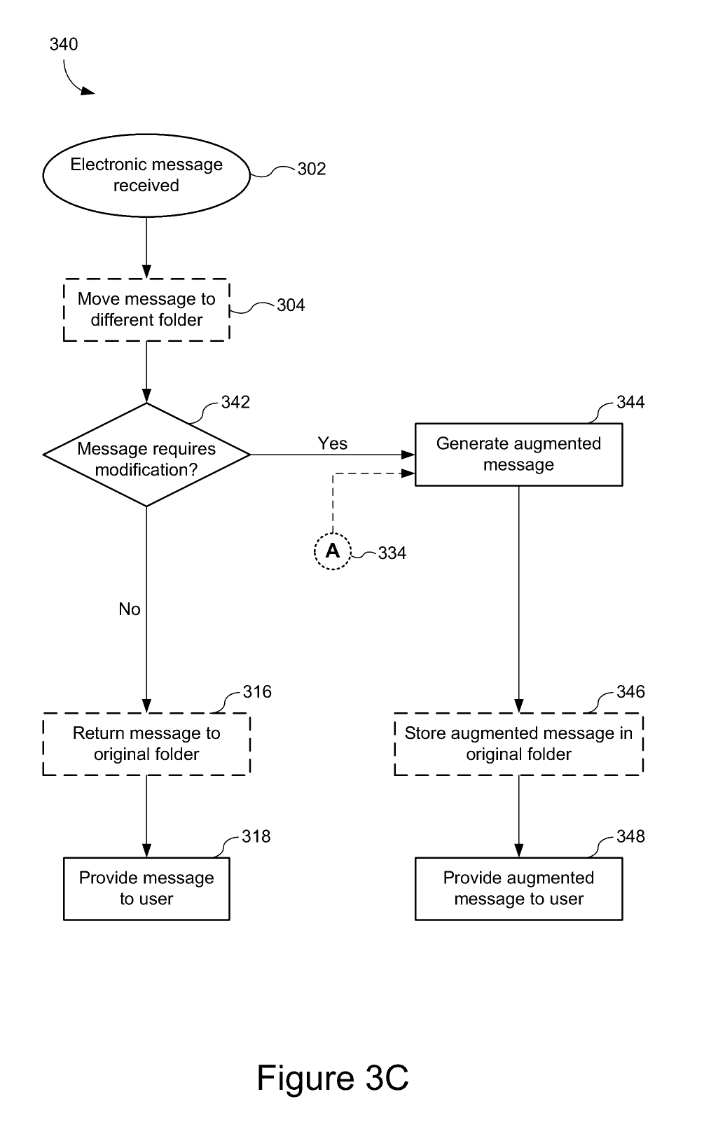

In some embodiments, modification server 120 includes modification module 121-1 and one or more processing units 122-1 (sometimes herein called CPUs, processors, or hardware processors, and sometimes implemented using microprocessors, microcontrollers, or the like) configured to execute instructions in one or more programs, including one or more programs in modification module 121-1. Network interface 123 provides an interface to communication network 140. More detailed discussion about the implementation of modification server 120 is provided below with respect to FIGS. 2A and 3A-3C.

Host server 110 includes one or more user accounts for electronic messages, as described in more detail below with respect to FIG. 2B. Electronic messages received at host server 110 are processed with respect to tracking remediation and/or message augmentation. In some embodiments, modification module 121-2 is implemented in host server 110. In some embodiments, electronic messages are processed with respect to tracking remediation and/or message augmentation by host server 110. In some embodiments, electronic messages are processed with respect to tracking remediation and/or message augmentation by modification server 120. In some embodiments, host server 110 and modification server 120 are part of a same server system. In some embodiments, host server 110 includes modification server 120, or a portion of modification server 120, as a component and/or as a subsystem. Host server is coupled to communication network 140 through a network interface (not shown in FIG. 1).

Information services 130 are coupled to communication network 140. In some embodiments, information services 130 include one or more databases with information related to one or more characteristics of electronic messages received at a user account on host server 110. Information services 130 may include Internet websites, such as social networking services or social media websites.

Client 150 is also coupled to communication network 140 and optionally includes browser 151. In some embodiments, browser 151 can be a general purpose Internet browser (sometimes called a Web browser) having a browser window for accessing and displaying electronic messages. In some embodiments, browser 151 can be a dedicated message application for accessing and displaying electronic messages. The electronic messages, which may include content that includes hypertext markup language (HTML) tags, may be rendered by browser 151 using any appropriate rendering methodology. A user may submit a request through client 150 to access electronic messages received at his account on host server 110. In some embodiments, prior to the first the time user views an electronic message at client 150, the electronic message is processed with respect to tracking remediation and/or message augmentation, and a modified message is generated and provided to the user at client 150.

FIG. 2A is a block diagram illustrating a modification server 120 of a network system 100, in accordance with some embodiments. Modification server 120 typically includes one or more processing units 122-1 (sometimes herein called CPUs, processors, or hardware processors, and sometimes implemented using microprocessors, microcontrollers, or the like) for executing modules, programs and/or instructions stored in memory 206 and thereby performing processing operations; memory 206; network interface 123; and one or more communication buses 208 for interconnecting these components. Communication buses 208 optionally include circuitry (sometimes called a chipset) that interconnects and controls communications between system components. Memory 206 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 206 optionally includes one or more storage devices remotely located from processor(s) 122-1. Memory 206, or alternately the non-volatile memory device(s) within memory 206, comprises a non-transitory computer readable storage medium. In some embodiments, memory 206, or the computer readable storage medium of memory 206 stores the following programs, modules, and data structures, or a subset or superset thereof:
an operating system 210 that includes procedures for handling various basic system services and for performing hardware dependent tasks;
a modification module 121-1 that is used for processing electronic messages;
a tracking identification module 214 that is used for identifying tracking content in and senders of electronic messages;
content storage 216 that is used for storing copies of tracking content with tracking features removed; and
information database 218 that is used for storing information used to augment electronic messages.

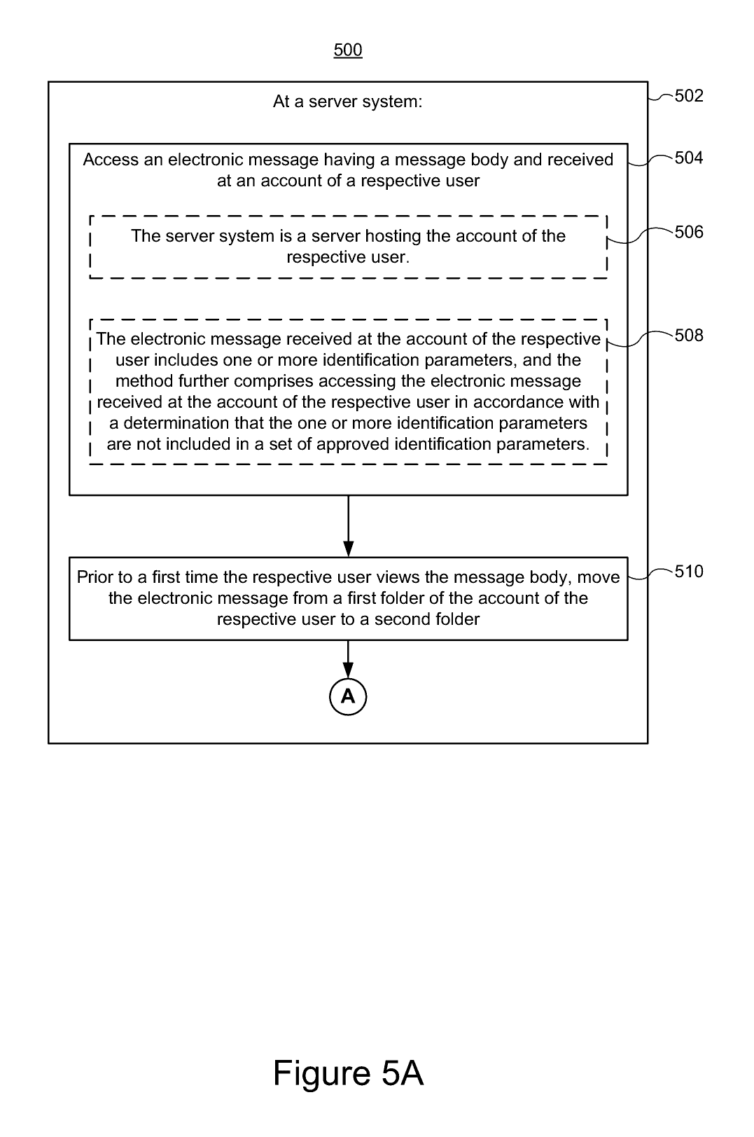

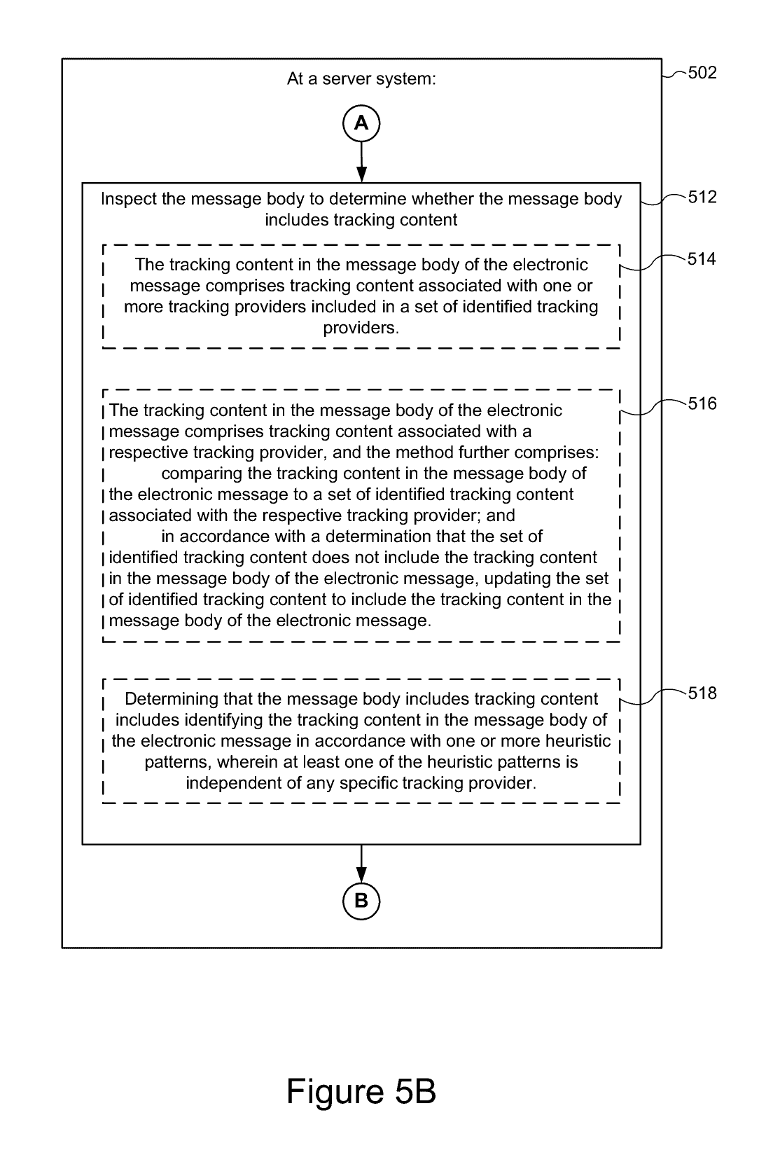

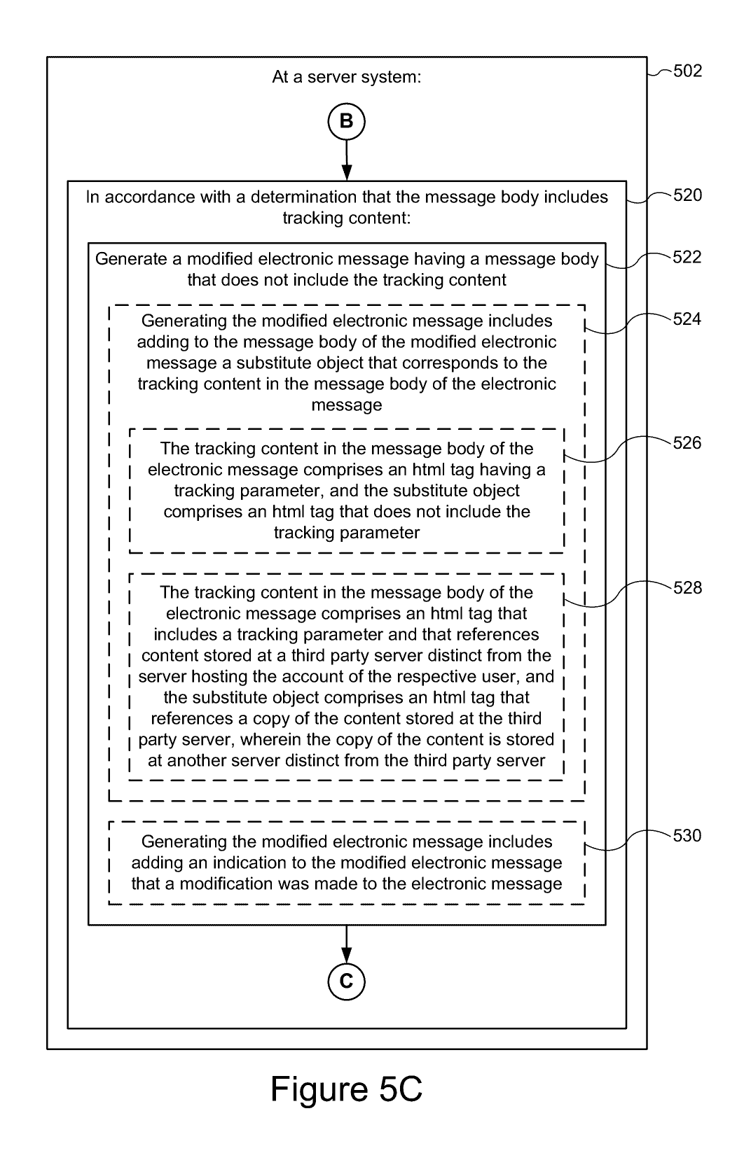

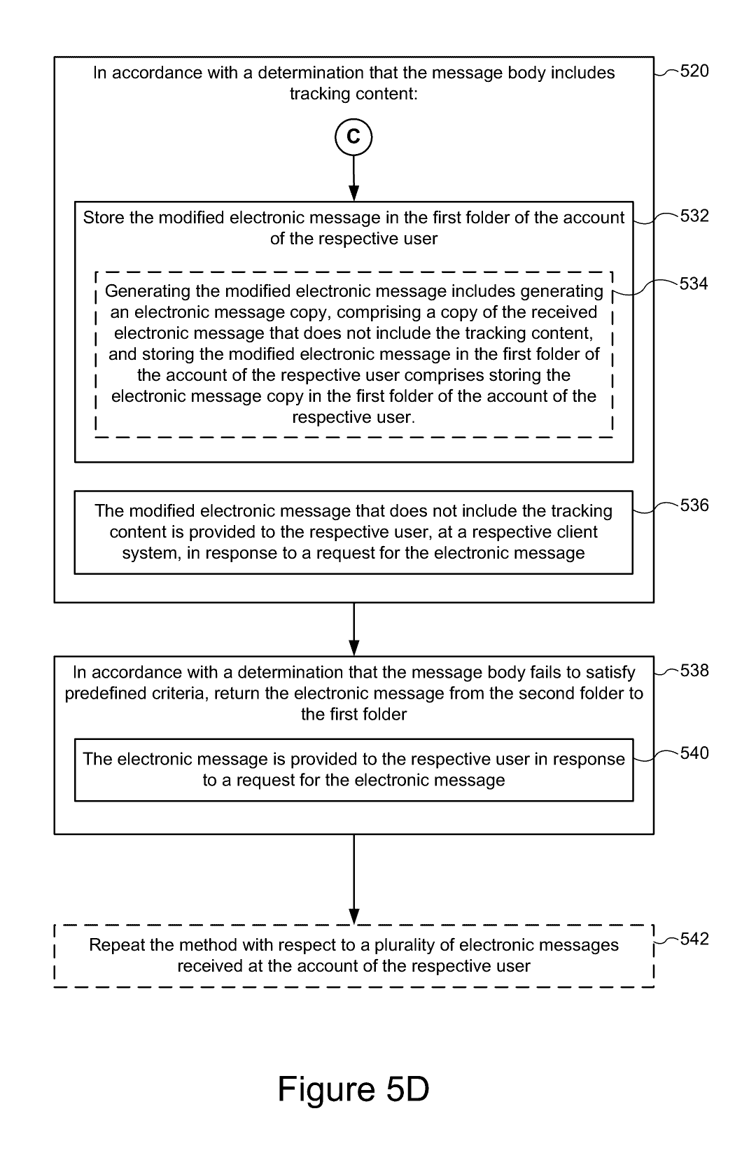

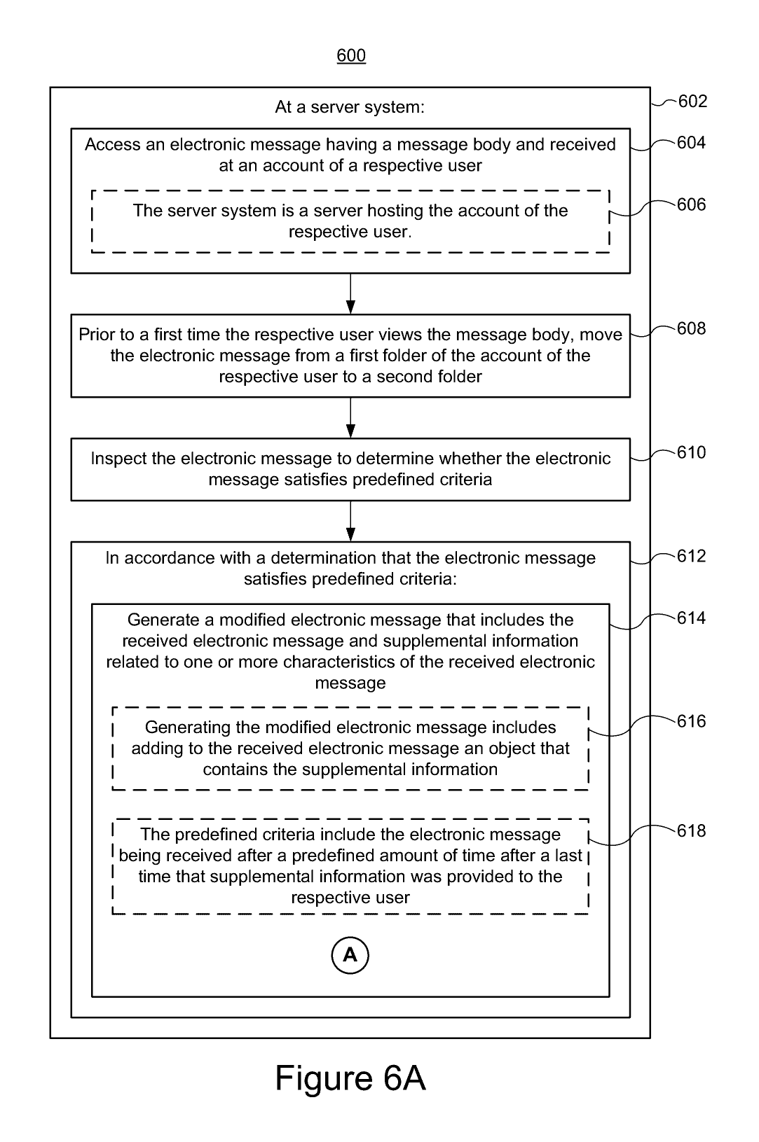

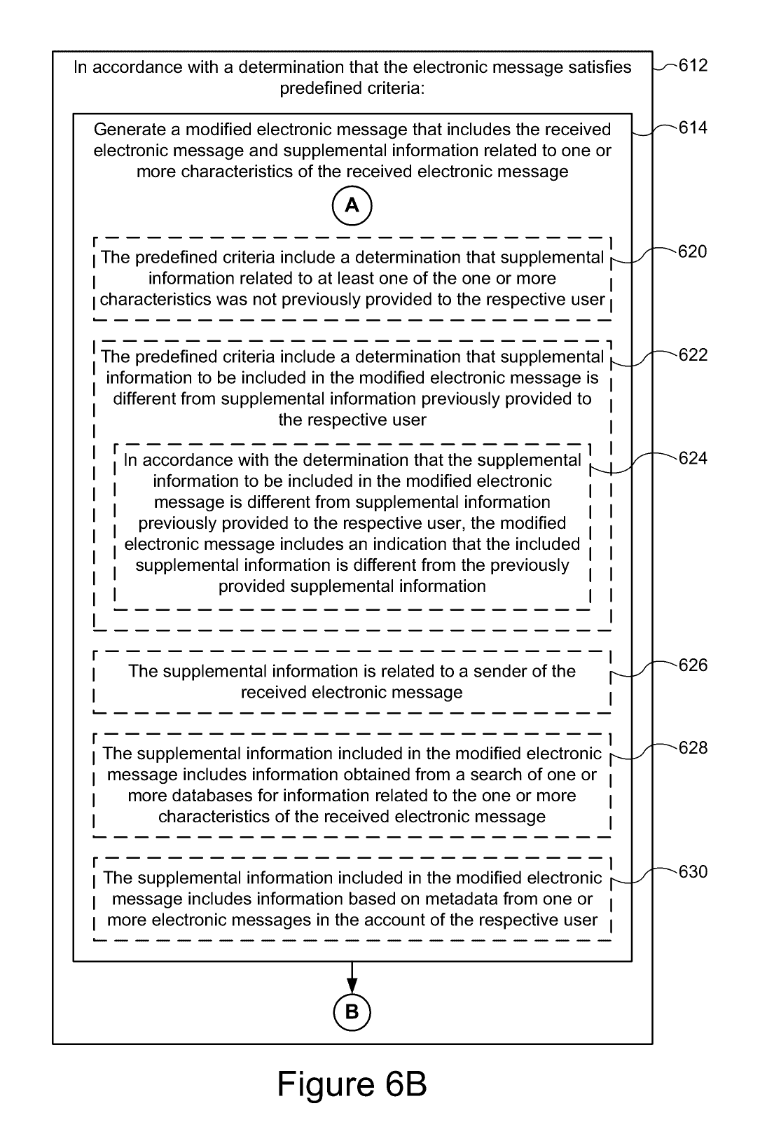

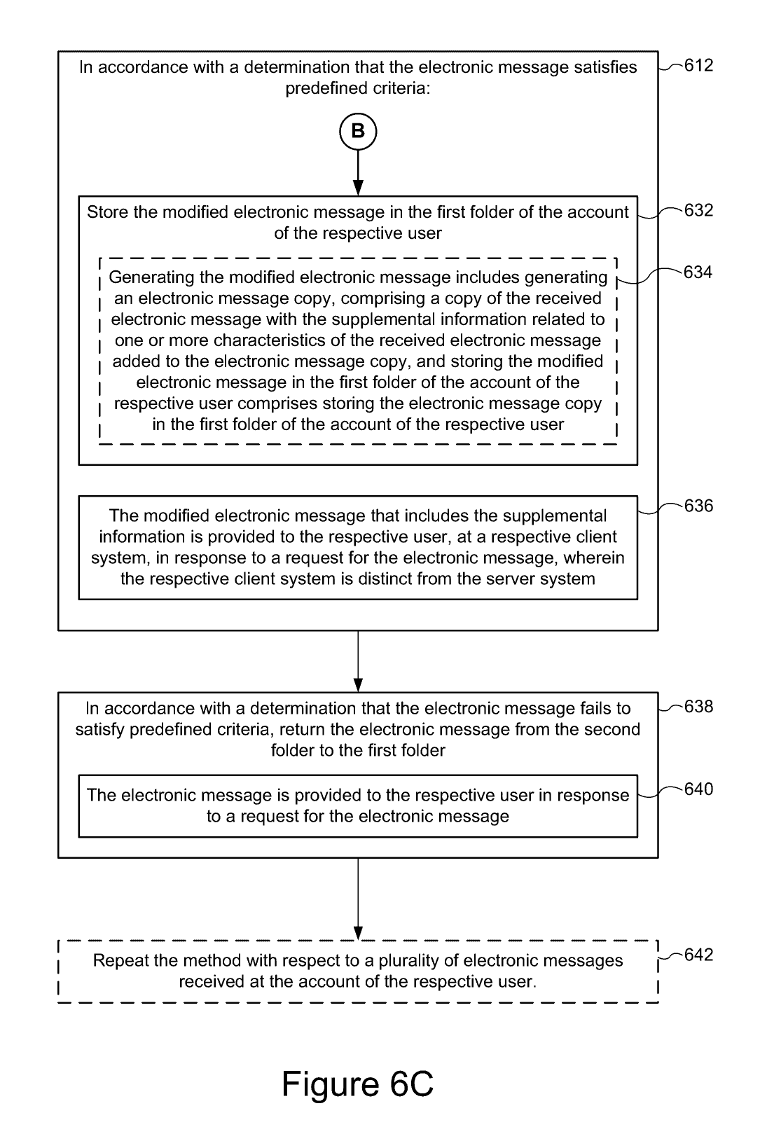

Each of the above identified elements may be stored in one or more of the previously mentioned memory devices that together form memory 206, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 206 may store a subset of the modules and data structures identified above. Furthermore, memory 206 may store additional modules and data structures not described above. In some embodiments, the programs, modules, and data structures stored in memory 206, or the computer readable storage medium of memory 206, provide instructions for implementing respective operations in the methods described below with reference to FIGS. 5A-5D and 6A-6C.

FIG. 2B is a block diagram illustrating a host server of a network system, in accordance with some embodiments. Host server 110 typically includes one or more processing units 222-1 (sometimes herein called CPUs, processors, or hardware processors, and sometimes implemented using microprocessors, microcontrollers, or the like) for executing modules, programs and/or instructions stored in memory 226 and thereby performing processing operations; memory 226; network interface 223; and one or more communication buses 228 for interconnecting these components. Communication buses 228 optionally include circuitry (sometimes called a chipset) that interconnects and controls communications between system components. Memory 226 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 226 optionally includes one or more storage devices remotely located from processor(s) 222-1. Memory 226, or alternately the non-volatile memory device(s) within memory 226, comprises a non-transitory computer readable storage medium. In some embodiments, memory 226, or the computer readable storage medium of memory 226 stores the following programs, modules, and data structures, or a subset or superset thereof:
an operating system 230 that includes procedures for handling various basic system services and for performing hardware dependent tasks;
messaging modules 232 that are used for managing electronic messaging between the host server 110 and other computers via network interface 223, such as the Internet, other wide area networks, local area networks, and so on, and that may include:
   management API 234 that is used by other computer systems to manage and interface with electronic messages on host server 110;
message database 236 that is used for storing electronic messages on host server 110, and that may include:
   one or more user account(s) 238, of which a respective user account 240 may include:
      an inbox folder 242 that is used as a container for electronic messages received at user account 240;
      a quarantine folder 244 that is used as a separate container for electronic messages; and
      one or more other folder(s) 246 that are used as containers for electronic messages.

Each of the above identified elements may be stored in one or more of the previously mentioned memory devices that together form memory 226, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 226 may store a subset of the modules and data structures identified above. Furthermore, memory 226 may store additional modules and data structures not described above. In some embodiments, the programs, modules, and data structures stored in memory 226, or the computer readable storage medium of memory 226, provide instructions for implementing respective operations in the methods described below with reference to FIGS. 5A-5D and 6A-6C.

Although FIGS. 2A and 2B show modification server 120 and host server 110, respectively, FIGS. 2A and 2B are intended more as functional descriptions of the various features which may be present in a modification server or a host server than as structural schematics of the embodiments described herein. In practice, and as recognized by those of ordinary skill in the art, items shown separately could be combined and some items could be separated. Further, as noted above, in some embodiments, one or more modules of modification server 120 are implemented in host server 110 of network system 100.

FIG. 3A illustrates a conceptual flowchart representation of a method of message modification 300, in accordance with some embodiments. In some embodiments, method 300 is performed by a server system, such as host server 110, modification server 120, a server system that includes host server 110 and modification server 120 (FIG. 1), or a server system that includes the functionalities of both host server 110 and modification server 120.

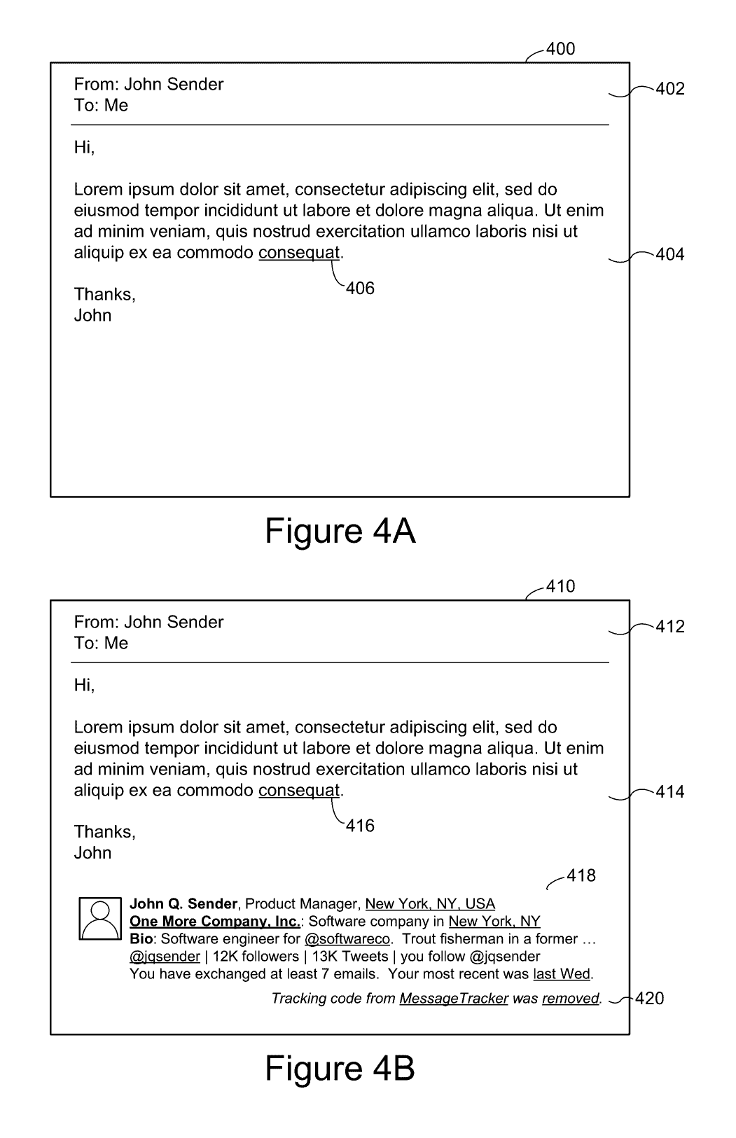

The method begins, in some embodiments, with an electronic message (e.g., electronic message 400, FIG. 4) being received (302) at the server system. In some embodiments, the electronic message (also referred to as “received message” or “original message”) is delivered by the server system to, and thus is received at, a respective account of a respective user (e.g., user account 240, FIG. 2B).

After the electronic message is received, and before the first time the user views the electronic message, the server system optionally moves (304) the electronic message to a different folder. For example, in some embodiments the electronic message is moved in accordance with a command send to host server 110 by modification server 120 using management API 234, FIG. 2B. Furthermore, in some such embodiments, modification server 120 receives a notification from host server 110 when new messages are received at the account of a respective user, after which modification server 120 sends a move message instruction to host server 110.

In some embodiments, the electronic message is moved from a folder in which it was initially received (e.g., inbox folder 242, FIG. 2B) to a different folder (e.g., quarantine folder 244, FIG. 2B or any of the other folder(s) 246, FIG. 2B). In some embodiments, a folder represents a message container used to subdivide electronic messages inside a user account. Thus, more generally, in some embodiments, the electronic message is moved from a message container with which it was originally associated to a different message container. It is noted that message containers may optionally be implemented as message labels or tags.

Next, the server system determines (306) whether the electronic message requires processing. In some embodiments, the electronic message requires processing if the message contains tracking content, as described below with respect to FIG. 3B. Furthermore, in some embodiments, the electronic message requires processing if the message requires modification by augmentation, as described below with respect to FIG. 3C.

In accordance with a determination that the message requires processing (306-Yes), the server system generates (308) a modified electronic message (e.g., using management API 234, FIG. 2B). In some embodiments, the modified message is a message without tracking content, as described below with respect to FIG. 3B. In some embodiments, the modified message is an augmented message, as described below with respect to FIG. 3C. In some embodiments, the modified message is an augmented message without tracking content (i.e., a message that is both augmented and without tracking content).

In some embodiments, generating the modified message includes making modifications to the received electronic message. For example, the electronic message may be modified “in-place” without generating a copy. In other embodiments, generating the modified message includes generating an electronic message copy that includes a copy of the contents of the received electronic message but omits, in some embodiments, tracking content, and/or adds, in some embodiments, supplemental information.

In some embodiments in which the received message was moved to a different folder (304), the server system stores (310) the modified message in the original folder (e.g., inbox folder 242, FIG. 2B) after generating the modified message (308) (e.g., using management API 234, FIG. 2B).

Optionally, in some embodiments, the server system deletes (312) the original message. For example, in embodiments in which the modified message is distinct from the original received message (e.g., the modified message includes a copy of the original message, as discussed above), the original message is deleted after the modified message is stored in the original folder (e.g., inbox folder 242, FIG. 2B), or alternatively at any point after the contents of the original received message are used to generate the modified message.

After generating the modified message (308) and, optionally, storing the modified message in the original folder (310) and/or deleting the original message (312), the server system provides (314) the modified message to the respective user. In some embodiments, the modified message is provided to the respective user in response to a request for the electronic message.

In some embodiments in which the received message was moved to a different folder (304) (e.g., quarantine folder 244, FIG. 2B), the server system returns (316) the received message to the original folder (e.g., inbox folder 242, FIG. 2B) in accordance with a determination that the message does not require processing (306-No).

Next, the server system provides (318) the original received message to the respective user. In some embodiments, the original received message is provided to the respective user in response to a request for the electronic message.

FIG. 3B illustrates a conceptual flowchart representation of a method 320 of message modification with respect to tracking remediation, in accordance with some embodiments. As described above with respect to FIG. 3A, an electronic message is received (302) at a server system and optionally moved to a different folder (304).

Next, the server system determines (322) whether the electronic message contains tracking content.

Tracking content may be implemented in any number of forms, some examples of which are presented herein. For example, in some embodiments the tracking content includes a tracking image. In some embodiments, a tracking image is implemented using an image tag, also called an <img> HTML tag, having an associated source (e.g., “src”) URL corresponding to image content stored on a third-party server (e.g., a tracking server). In accordance with an electronic message being opened, wherein the electronic message includes a tracking image, an email client renders the message body of the electronic message, including rendering the tracking image. In some embodiments, rendering the tracking image includes requesting the image content of the tracking image from the third-party server. The request for the image content of the tracking image informs the third-party server that the electronic message was opened.

In some embodiments, the image content of the tracking image is a transparent image and/or has a small size, and is not visible to a user of the email client. In some embodiments, the tracking image is implemented as a so-called tracking pixel, wherein the image content has a size of 1 pixel by 1 pixel.

In some embodiments, the source URL associated with the <img> tag contains additional characteristics allowing the third-party server to identify the message recipient (e.g., the user and/or the user account that received the electronic message). For example, the source URL may contain an identification parameter that is unique to and that identifies the message recipient. An example source URL associated with a tracking pixel is shown as follows:

(01) http://tracking.server.t1d/images/transparent1×1.gif?userID=123456abc

The example source URL above points to an image called “transparent1×1.gif” which, in some embodiments, is a transparent image having a size of 1 pixel by 1 pixel, as discussed above, and is stored on third-party server “tracking. server. t1d”. In addition, the example source URL has an identification parameter, such as “userID”, having a value, such as “123456abc”, that uniquely identifies the message recipient. If a message having this tracking content were rendered for display at a respective client, for example by browser application 151 at client 150 (FIG. 1), a request that includes the identification parameter would be sent to the third-party server “tracking.server.t1d”, which informs “tracking.server.t1d” that the electronic message to recipient “123456abc” was opened. However, as described herein, the message is modified to remove or modify the tracking content to avoid this result.

As another example, in some embodiments the tracking content includes a tracked link. In some embodiments, a tracked link is implemented using an anchor tag, also called an <a> HTML tag, having an associated hypertext reference (e.g., “href”) URL corresponding to a web page, document, or other content (e.g., a “target”) stored on a third-party server. In accordance with a user activating the link (e.g., by clicking or tapping) to open the hypertext reference URL, a request is sent to the third-party server to retrieve the corresponding content. The request for the corresponding content informs the third-party server that the link was activated.

In some embodiments, as described above with respect to tracking images, the reference URL associated with the <href> tag contains an identification parameter, such as “userID”, having a value, such as “123456abc”, that uniquely identifies the message recipient. An example tracked link is shown as follows:

(02) http://target.website.t1d/main.asp?userID=123456abc

In some embodiments, a tracked link is implemented as a wrapped link, wherein the hypertext reference URL associated with the wrapped link points to a first third-party server, e.g., a tracking server, and includes, as a parameter, a target URL that corresponds to a target web page, document, or other content (“target content”) stored on a second third-party server, e.g., a content server, which in some embodiments is distinct from the tracking server. In some embodiments, the hypertext reference URL associated with the wrapped link also includes a user-identifying parameter. In accordance with a user activating the wrapped link to open the hypertext reference URL, the tracking server is informed that the link was activated, and the user is redirected to the target URL to access the target content on the content server. An example wrapped link is shown as follows:

(03) http://tracking.server.t1d/main.asp?userID=123456abc&targetURL=target.website.t1d

In the example wrapped link above, in accordance with the user activating the wrapped link, the tracking server “tracking.server.t1d” is informed that the link was activated, in this case by message recipient “123456abc” indicated by identification parameter “userID”, which uniquely identifies the message recipient, and the user is redirected to the target content “target.website.t1d” indicated by target URL parameter “targetURL”.

In some circumstances, the tracking content in the message body of a respective electronic message includes tracking content identified as being associated with one or more tracking providers in a set of identified tracking providers. For example, the server system may maintain a list or database that includes identified or known tracking providers (e.g., in tracking identification module 214, FIG. 2A). The list or database may also include identified tracking content known to be associated with the identified tracking providers. In some embodiments, determining that the message body includes tracking content includes determining that the message body includes tracking content associated with one or more tracking providers in the list. For example, a list or database of identified tracking providers may include the tracking server “tracking.server.t1d” in examples (01) and (03), and may further include tracking pixel “transparent1×1.gif” and identification parameter “userID” as known tracking mechanisms or tracking content for tracking server “tracking.server.t1d”.

In some circumstances, the tracking content in the message body of a respective electronic message includes tracking content from a respective tracking provider, and the respective tracking provider is known and included in a database of identified tracking providers along with a set of identified tracking content known to be associated with the respective tracking provider, but the tracking content in the message body of the electronic message does not match any of the identified tracking content in the database. That is, the tracking content in the message body of the electronic message does not match any of the identified tracking content known to be associated with the respective tracking provider.

Thus, in some embodiments, the server system compares the tracking content in the message body of the electronic message to the set of identified tracking content associated with the respective tracking provider. In accordance with a determination that the set of identified tracking content does not include (i.e., does not match) the tracking content in the message body of the electronic message, in some embodiments, the server system updates the set of identified tracking content to include the tracking content in the message body of the electronic message. Thus, the tracking content in the message body of the electronic message is added to the set of identified tracking content known to be associated with the respective tracking provider.

In some embodiments, determining that the message body includes tracking content includes identifying the tracking content in the message body of the electronic message in accordance with one or more heuristic patterns. In some embodiments, the heuristic patterns are independent of any specific tracking provider. For example, if an <img> HTML tag is present in a message body with a source (“src”) URL attribute and also with “width” and “height” attributes with values less than or equal to 2 pixels, the image may be a tracking pixel or a small tracking image. More generally, content in a message body may be evaluated to determine whether it satisfies particular criteria indicative that the content is tracking content. Furthermore, in conjunction with identifying the tracking content of the electronic message in accordance with one or more heuristic patterns, a tracking provider associated with the identified tracking content may also be identified, and, optionally, the tracking content and/or the associated tracking provider may be added to a database of identified or known tracking content and tracking providers, as discussed above.

In accordance with a determination that the electronic message, or more specifically the message body of the electronic message, includes tracking content (322-Yes), the server system generates (324) an electronic message without tracking content, or, in other words, a modified electronic message having a message body that does not include the tracking content. In some embodiments, the received electronic message includes other content in addition to the tracking content, and the modified electronic message includes the other content of the received electronic message.

For example, if the message body of the received electronic message includes a tracking pixel, the tracking pixel is removed or omitted from the modified message.

In some embodiments, however, the image content of a tracking image is a visible image to be displayed in the message body of the electronic message, rather than a transparent pixel. An example source URL associated with a tracked visible image is shown as follows:

(04) http://tracking.server.t1d/images/visibleimage.gif?userID=123456abc
where “visibleimage.gif” is the target visible image.

In some such embodiments, removing the tracked image altogether would include removing the visible image. Alternatively, however, the visible image may in some embodiments be retained in some form in the modified message. In some embodiments in which the source URL of a tracked visible image is a wrapped link (e.g., the source URL includes, as a parameter, the target URL of the image content), the wrapped link in the message body is substituted with (i.e., replaced by) the target URL such that the modified message includes the target URL in place of the image source URL. As a result, the original wrapped link in the message body is removed. Furthermore, substituting the target URL for the wrapped link in the message body results in any identification parameter that was included in the source URL of the wrapped link also being removed. When the resulting modified electronic message is rendered, the image content is retrieved and included in the rendered electronic message, without providing tracking information to a tracking server.

In some embodiments in which the source URL of a tracked visible image includes an identification parameter (e.g., “userID”), removing the identification parameter from the source URL may break the source URL, rendering the URL non-functional. However, in some embodiments, in accordance with a determination that the identification parameter can be removed from the source URL without breaking the source URL, the modified message includes the source URL to the visible image but with the identification parameter omitted.

Similarly, for tracked links, if the tracking content is a wrapped link with a target URL as a parameter, in some embodiments the modified message may include the target URL in place of the wrapped link. In some embodiments in which the tracked link includes a hypertext reference URL and an identification parameter, the modified message may include the hypertext reference URL but with the identification parameter omitted.

In some embodiments, the tracking content references content stored at a third-party server, such as a tracking server or a content server. In some embodiments, the server system copies the referenced content stored at the third-party server, and stores the copy of the referenced content at another server (e.g., modification server 120, FIG. 1, or in a component thereof such as content storage 216, FIG. 2A) distinct from the third-party server. In some embodiments, generating the modified message includes substituting the tracking content reference to the referenced content on the third-party server with a substitute reference to the copy of the referenced content on the other server distinct from the third-party server. In some embodiments, substituting the tracking content reference with the substitute reference omits or bypasses tracking mechanisms associated with the referenced content on the third-party server.

Next, if the received message was moved to a different folder (304), in some embodiments, the server system stores (326) the modified electronic message without tracking content in the original folder. Alternatively, in some embodiments, the server system may determine whether the electronic message requires other processing (325, to 332), as described in more detail below.

Also optionally, in some embodiments in which the modified message without tracking content is distinct from the original received message (e.g., because the modified message was generated using a copy of the original received message), the server system deletes (328) the original received (tracked) message, as discussed above with respect to FIG. 3A.

Next, after generating the modified message without tracking content (324) and, optionally, storing the modified message without tracking content in the original folder (326) and/or deleting the original (tracked) message (328), the server system provides (330) the modified message without tracking content to the respective user, in some embodiments in response to a request for the electronic message.

Referring back to operation 322 of FIG. 3B, in some embodiments, in accordance with a determination that the message body of the received electronic message does not include tracking content (322-No), the server system optionally determines (332) whether the electronic message requires other processing. As noted above, in some embodiments, the server system may also optionally determine (332) whether the electronic message requires other processing after processing the electronic message for tracking content (322-Yes and 324).

In accordance with a determination that the electronic message requires other processing (332-Yes), the server system optionally performs additional operations for the other processing required. For example, the server system may then process the electronic message with respect to another form of message modification (334), such as with respect to message augmentation (344), as described in more detail below with respect to FIG. 3C.

In accordance with a determination that the electronic message does not contain tracking content (322-No) and, optionally, that the electronic message does not require other processing (332-No), the server system optionally returns (316) the electronic message to the original folder and provides (318) the electronic message to the user, as described above with respect to FIG. 3A.

It should be noted that, in embodiments in which the server system generates (324) a modified message without tracking content, and subsequently determines that the message does not require other processing (325-No), the server system proceeds as discussed above with respect to the operations following generating the modified message without tracking content.

FIG. 3C illustrates a conceptual flowchart representation of a method of message modification 340 with respect to message augmentation, in accordance with some embodiments. As described above with respect to FIG. 3A, an electronic message is received (302) at a server system and optionally moved to a different folder (304).

Next, the server system determines (342) whether the electronic message requires modification. In some embodiments, the electronic message requires modification if it satisfies predefined criteria. In accordance with a determination that the electronic message requires modification, the server system generates (344) an augmented message. In some embodiments, generating an augmented message includes generating a modified electronic message that includes the received electronic message and supplemental information related to one or more characteristics of the received electronic message. As an example, supplemental information included in the modified electronic message may be related to a sender of the electronic message, including but not limited to professional information, biographical information, contact information, publications, and/or communication statistics (such as how many times the user has exchanged emails with the sender or the last time an email was sent to or received from the sender).

In some embodiments, the electronic message requires modification if supplemental information was not previously provided to the user (such as, for example, if the user has not previously received electronic messages from the sender of the electronic message; if the user has not previously received more than a predefined number of electronic messages from the sender; or if the user has previously received electronic messages from the sender at a frequency less than a predefined threshold).

In some embodiments, the electronic message requires modification if a predefined amount of time (e.g., a week, or 10 days, or any appropriate value from 1 day to 30 days) has elapsed after a last time that supplemental information was provided to the user.

In some embodiments, the electronic message requires modification if supplemental information to be included in the augmented message is different from supplemental information previously provided to the respective user. For example, in some embodiments, if newly available supplemental information for the sender of the electronic message is different from supplemental information previously provided (e.g., the last time supplemental information was provided) to the respective user, the electronic message requires modification. In some embodiments, the electronic message requires modification if the last supplemental information provided to the respective user satisfied predefined staleness criteria, indicating that the previously provided supplemental information is or might be stale or out-of-date. In some such embodiments, the augmented message includes an indication (e.g., by highlighting or otherwise marking the new supplemental information) that the included supplemental information is different from the previously provided supplemental information.

In some embodiments, supplemental information is stored in a local information database (e.g., information database 218, FIG. 2A). In some embodiments, the supplemental information stored in the local information database includes supplemental information previously provided to the user. The server system may perform a search of one or more databases (e.g., information services 130, FIG. 1) for information related to one or more characteristics of the received electronic message. For example, information related to a sender of the received electronic message may be obtained from a search of the Internet, social messaging services, or other databases. The server system may compare information obtained from the search with previously provided supplemental information stored in the local information database. Optionally, information related to the sender of the received message includes information provided by the sender to a service provider or in a public profile. In some embodiments, determining that the electronic message requires modification includes determining that the information obtained from the search is different from previously provided supplemental information stored in the local information database.

In some embodiments, the electronic message requires modification if a predefined amount of time has elapsed since supplemental information stored in the local information database was last stored or updated.

In some embodiments, supplemental information may be obtained from a search of the one or more databases (e.g., information services 130, FIG. 1), and stored in the local information database (e.g., information database 218, FIG. 2A). In some embodiments, the one or more databases may be searched independently of an electronic message being received at the user account. For example, the local information database may be periodically updated with information relevant to a sender of electronic messages received at the user account independent of an electronic message being contemporaneously received from the sender. In some embodiments in which an electronic message is received at a user account subsequent to an update of the local information database, determining that the electronic message requires modification includes determining that information stored in the local information database is different from supplemental information previously presented to the user.

In some embodiments, the supplemental information included in the augmented message includes information based on metadata from one or more electronic messages in the account of the user (e.g., user account 240, FIG. 2B). For example, information related to a sender of the received electronic message may be obtained from a search of other messages received from the sender.

In some embodiments, generating the augmented message includes adding to the received electronic message an object that contains the supplemental information. As discussed above with respect to FIG. 3A, the received electronic message may be modified in-place to add the object containing the supplemental information, or a modified message may be generated. In some embodiments in which a modified message is generated, the modified message includes a copy of the received electronic message and the object containing the supplemental information. Furthermore, in some embodiments, the object containing the supplemental information is presented in the message header or message body of the electronic message.

Next, if the received message was moved to a different folder (304), in some embodiments, the server system stores (346) the augmented message in the original folder.

Although not shown in FIG. 3C, as discussed above with respect to FIGS. 3A-3B, the server system may optionally delete the original received message, if the augmented message is distinct from the original received message.

Next, after generating the augmented message (344) and, optionally, storing the augmented message in the original folder (346) and/or deleting the original received message, the server system provides (348) the augmented message to the user, in some embodiments in response to a request for the electronic message.

As discussed above, in some embodiments, the server system optionally processes the electronic message with respect to message augmentation (344) after processing the electronic message with respect to tracking remediation (334). In such embodiments, the modified message provided to the user (348) is an augmented message without tracking content (i.e., a message that is both augmented and without tracking content).

Those skilled in the art will recognize that tracking remediation and augmentation may be performed in any order and/or in conjunction with other forms of message modification and that the modified message ultimately provided to the user may include any combination of modifications.

Additional details concerning each of the processing steps for methods 300, 320, and 340, as well as details concerning additional processing steps, are presented herein with reference to FIGS. 5A-5D and 6A-6C.

FIGS. 4A and 4B illustrate an implementation of an electronic message before message modification and after message modification, respectively, in accordance with some embodiments. Referring to FIG. 4A, electronic message 400 includes message header 402 and message body 404. Message body 404 includes tracked link 406.

In conjunction with or subsequent to electronic message 400 being received at an account of a user (e.g., user account 240, FIG. 2B), electronic message 400 is processed with respect to tracking remediation, message augmentation, and/or other forms of message modification. Referring to FIG. 4B, electronic message 410 includes message header 412 and message body 414. Electronic message 410 is a modified electronic message resulting from both tracking remediation processing and message augmentation processing, as described above with respect to FIGS. 3A-3C. Thus, electronic message 410 includes message body 404 of electronic message 400, without tracking content. In other words, electronic message 410 with hyperlink 416 in message body 414 is generated from electronic message 400 with tracked link 406 in message body 404 as described above with respect to FIG. 3B. Moreover, electronic message 410 includes an indication 420 that tracking content was removed.

In addition, message body 414 of electronic message 410 includes supplemental information 418, as described above with respect to FIG. 3C. As shown in

FIG. 4B, supplemental information 418 includes professional information for the sender “John Q. Sender” of electronic message 410, biographical information, contact information, and communication statistics. Supplemental information may optionally include a photograph of the sender. In some embodiments, the supplemental information may include links to additional resources related to the included supplemental information. For example, in FIG. 4B, the element “New York, N.Y., USA” may link to a map, while the element “@jqsender” may link to a social media or other online profile.

FIGS. 5A-5D illustrate a flowchart representation of a method 500 of tracking remediation, in accordance with some embodiments. With reference to FIG. 1, in some embodiments, method 500 is performed by a server system, such as host server 110, modification server 120, a server system that includes host server 110 and modification server 120 (FIG. 1), or a server system that includes the functionalities of both host server 110 and modification server 120 (as discussed above with respect to FIGS. 3A-3C). In some embodiments, some of the operations (or alternatively, steps) of method 500 are performed at a modification server (e.g., modification server 120, FIG. 1) that is operatively coupled with a host server (e.g., host server 110, FIG. 1), and other operations of method 500 are performed at the host server. In some embodiments, a modification server (e.g., modification server 120, FIG. 1) may access a host server (e.g., host server 110, FIG. 1) and perform some of the operations of method 500 at the host server by sending commands to the host server. In some embodiments, the method 500 is governed by instructions that are stored in a non-transitory computer readable storage medium and that are executed by one or more processors of a device, such as the one or more processing units (CPUs) 122-1 of modification server 120 (FIGS. 1 and 2A) and/or one or more processing units (CPUs) 222-1 of host server 110 (FIG. 2B).

With reference to FIGS. 2A and 2B, in some embodiments, the operations of method 500 are performed, at least in part, by a modification module (e.g., modification module 121-1, FIG. 2A), a tracking identification module (e.g., tracking identification module 214, FIG. 2A), messaging modules (e.g., messaging modules 232, FIG. 2B) and using content storage (e.g., content storage 216, FIG. 2A) and a message database (e.g., message database 236, FIG. 2B). For ease of explanation, the following describes method 500 as performed by a server system.

With reference to FIG. 5A, in some embodiments, the server system (502) accesses (504) an electronic message (e.g., electronic message 400, FIG. 4A) having a message body (e.g., message body 404, FIG. 4A) and received at an account of a respective user (e.g., user account 240, FIG. 2B), as explained above with reference to operation 302 of methods 300 and 320. In some embodiments, the server system is (506) a server hosting the account of the respective user (e.g., host server 110, FIGS. 1 and 2B).

In some embodiments, some electronic messages with tracking content are not accessed, and thereby are bypassed and provided to the user without modification. For example, in some embodiments, the electronic message received at the account of the respective user includes (508) one or more identification parameters, and the method further comprises accessing the electronic message received at the account of the respective user in accordance with a determination that the one or more identification parameters are not included in a set of approved identification parameters. The set of approved identification parameters is sometimes referred to as a “whitelist,” and may be stored, for example, in tracking identification module 214, FIG. 2A. In some embodiments, the identification parameter may identify, indicate or correspond to a sender of the electronic message, such that messages from a sender who is not on the whitelist are accessed and processed with respect to tracking remediation, as described herein, while messages from senders already on the whitelist (e.g., trusted senders) are not accessed or processed.

Next, in some embodiments, prior to a first time the respective user views the message body (e.g., prior to a first time the respective user views the message body in response to a user-initiated request for the electronic message), the server system moves (510) the electronic message from a first folder (e.g., inbox folder 242, FIG. 2B) of the account of the respective user to a second folder (e.g., quarantine folder 244, FIG. 2B), as explained above with reference to operation 304 of methods 300 and 320.

Next, with reference to FIG. 5B, in some embodiments, the server system inspects (512) the message body (e.g., message body 404, FIG. 4A) to determine whether the message body includes tracking content, such as a tracking beacon, pixel, image, or URL, which, when downloaded, identifies the message body as having been read by the user and/or identifies the user, as explained above with reference to operation 306 of method 300, and more specifically with reference to operation 322 of method 320. In some circumstances, the tracking content in the message body of the electronic message comprises (514) tracking content associated with one or more tracking providers included in a set of identified tracking providers. In some circumstances, the tracking content in the message body of the electronic message comprises (516) tracking content associated with a respective tracking provider, and thus in some embodiments the method further comprises: comparing the tracking content in the message body of the electronic message to a set of identified tracking content associated with the respective tracking provider; and, in accordance with a determination that the set of identified tracking content does not include the tracking content in the message body of the electronic message, updating the set of identified tracking content to include the tracking content in the message body of the electronic message. In some embodiments, determining that the message body includes tracking content includes (518) identifying the tracking content in the message body of the electronic message in accordance with one or more heuristic patterns, wherein at least one of the heuristic patterns is independent of any specific tracking provider.

Next, with reference to FIG. 5C, in some embodiments, in accordance with a determination that the message body includes tracking content (520) (e.g., tracked link 406, FIG. 4B), the server system generates (522) a modified electronic message (e.g., electronic message 410, FIG. 4B) having a message body that does not include the tracking content (e.g., message body 414, FIG. 4B), as explained above with reference to operation 308 of method 300, and more specifically with reference to operation 324 of method 320. In some embodiments, the message body of the modified electronic message includes content of the message body of the received electronic message other than the tracking content.

In some embodiments, generating the modified electronic message includes (524) adding to the message body of the modified electronic message a substitute object that corresponds to the tracking content in the message body of the electronic message (e.g., hyperlink 416, FIG. 4B, which does not include tracking content). The substitute object may be any of the specific embodiments described herein and/or discussed in U.S. Provisional Patent Application No. 62/183,098, or may be a generalization of any of those specific embodiments. In some embodiments, the tracking content in the message body of the electronic message comprises (526) an html tag having a tracking parameter, and the substitute object comprises an html tag that does not include the tracking parameter. In some embodiments, the tracking content in the message body of the electronic message comprises (528) an html tag that includes a tracking parameter and that references content stored at a third party server distinct from the server hosting the account of the respective user, and the substitute object comprises an html tag that references a copy of the content stored at the third party server, wherein the copy of the content is stored at another server distinct from the third party server. In other embodiments, an html tag that includes tracking content may be removed completely. More examples and explanations of various forms of tracking content and remediation options are included above with respect to operations 322 and 324 of method 320, FIG. 3B.

In some embodiments, generating the modified electronic message includes (530) adding an indication to the modified electronic message that a modification was made to the electronic message. In some embodiments, the indication may be included in the message body (e.g., indication 420, FIG. 4B) and/or implemented as a message label or tag.

Next, with reference to FIG. 5D, in some embodiments, in accordance with the determination that the message body includes tracking content (520), the server system stores (532) the modified electronic message (e.g., electronic message 410, FIG. 4B) in the first folder (e.g., inbox folder 242, FIG. 2B) of the account of the respective user, as explained above with reference to operation 310 of method 300, and more specifically with reference to operation 326 of method 320. In some embodiments, generating the modified electronic message includes (534) generating an electronic message copy, comprising a copy of the received electronic message that does not include the tracking content, and storing the modified electronic message in the first folder of the account of the respective user comprises storing the electronic message copy in the first folder of the account of the respective user.

In some embodiments, the modified electronic message that does not include the tracking content (e.g., electronic message 410, FIG. 4B) is provided to the respective user (536), at a respective client system (e.g., client 150, FIG. 1), in response to a request for the electronic message, as explained above with reference to operation 314 of method 300, and more specifically with reference to operation 330 of method 320.

Next, in some embodiments, in accordance with a determination that the message body fails to satisfy predefined criteria (e.g., that the message body does not include tracking content and/or does not require other processing), the server system returns (538) the electronic message from the second folder (e.g., quarantine folder 244, FIG. 2B) to the first folder (e.g., inbox folder 242, FIG. 2B), as explained above with reference to operation 316 of methods 300 and 320. In some embodiments, the electronic message is provided to the respective user (540) in response to a request for the electronic message, as explained above with reference to operation 318 of methods 300 and 320.

In some embodiments, the server system repeats (542) the method with respect to a plurality of electronic messages received at the account of the respective user.

FIGS. 6A-6C illustrate a flowchart representation of a method 600 of message augmentation, in accordance with some embodiments. With reference to FIG. 1, in some embodiments, method 600 is performed by a server system, such as host server 110, modification server 120, a server system that includes host server 110 and modification server 120 (FIG. 1), or a server system that includes the functionalities of both host server 110 and modification server 120 (as discussed above with respect to FIGS. 3A-3C). In some embodiments, some of the operations (or alternatively, steps) of method 600 are performed at a modification server (e.g., modification server 120, FIG. 1) that is operatively coupled with a host server (e.g., host server 110, FIG. 1), and other operations of method 600 are performed at the host server. In some embodiments, a modification server (e.g., modification server 120, FIG. 1) may access a host server (e.g., host server 110, FIG. 1) and perform some of the operations of method 600 at the host server by sending commands to the host server. In some embodiments, the method 600 is governed by instructions that are stored in a non-transitory computer readable storage medium and that are executed by one or more processors of a device, such as the one or more processing units (CPUs) 122-1 of modification server 120 (FIGS. 1 and 2A) and/or one or more processing units (CPUs) 222-1 of host server 110 (FIG. 2B).

With reference to FIGS. 2A and 2B, in some embodiments, the operations of method 600 are performed, at least in part, by a modification module (e.g., modification module 121-1, FIG. 2A), messaging modules (e.g., messaging modules 232, FIG. 2B) and using an information database (e.g., information database 218, FIG. 2A) and a message database (e.g., message database 236, FIG. 2B). For ease of explanation, the following describes method 600 as performed by a server system.

With reference to FIG. 6A, in some embodiments, the server system (602) accesses (604) an electronic message having a message body and received at an account of a respective user, as explained above with reference to operation 302 of methods 300 and 340. In some embodiments, the server system is (606) a server hosting the account of the respective user (e.g., host server 110, FIGS. 1 and 2B).

Next, in some embodiments, prior to a first time the respective user views the message body, the server system moves (608) the electronic message from a first folder (e.g., inbox folder 242, FIG. 2B) of the account of the respective user to a second folder (e.g., quarantine folder 244, FIG. 2B), as explained above with reference to operation 304 of methods 300 and 340.

Next, in some embodiments, the server system inspects (610) the electronic message (e.g., electronic message 400, FIG. 4A) to determine whether the electronic message satisfies predefined criteria, as explained above with reference to operation 306 of method 300, and more specifically with reference to operation 342 of method 320.

Next, in accordance with a determination that the electronic message satisfies predefined criteria (612), the server system generates (614) a modified electronic message (e.g., electronic message 410, FIG. 4B) that includes the received electronic message and supplemental information (e.g., supplemental information 418, FIG. 4B) related to one or more characteristics of the received electronic message, as explained above with reference to operation 308 of method 300, and more specifically with reference to operation 344 of method 340. In some embodiments, generating the modified electronic message includes (616) adding to the received electronic message an object that contains the supplemental information. In some embodiments, the predefined criteria include (618) the electronic message being received after a predefined amount of time after a last time that supplemental information was provided to the respective user. Furthermore, in some embodiments, the electronic message is first modified by removing or modifying tracking content to produce a temporary version of the electronic message, and then adding supplemental information to the temporary version of the electronic message to generate the modified electronic message.

With reference to FIG. 6B, in some embodiments, the predefined criteria include (620) a determination that supplemental information related to at least one of the one or more characteristics was not previously provided to the respective user.

In some embodiments, the predefined criteria include (622) a determination that supplemental information to be included in the modified electronic message is different from supplemental information previously provided to the respective user. In some such embodiments, in accordance with the determination that the supplemental information to be included in the modified electronic message is different from supplemental information previously provided to the respective user, the modified electronic message includes (624) an indication that the included supplemental information is different from the previously provided supplemental information.

In some embodiments, the supplemental information is (626) related to a sender of the received electronic message. In some embodiments, the supplemental information included in the modified electronic message includes (628) information obtained from a search of one or more databases (e.g., information services 130, FIG. 1) for information related to the one or more characteristics of the received electronic message. In some embodiments, the supplemental information included in the modified electronic message includes (630) information based on metadata from one or more electronic messages in the account of the respective user.

More detail regarding the predefined criteria for determining that the received electronic message requires modification by augmentation, and regarding various forms of supplemental information for augmentation, are included above with respect to operations 342 and 344 of method 340, FIG. 3C.

Next, with reference to FIG. 6C, in some embodiments, in accordance with the determination that the electronic message satisfies predefined criteria (612), the server system stores (632) the modified electronic message in the first folder of the account of the respective user, as explained above with reference to operation 310 of method 300, and more specifically with reference to operation 346 of method 340. In some embodiments, generating (614) the modified electronic message includes (634) generating an electronic message copy, comprising a copy of the received electronic message with the supplemental information, related to one or more characteristics of the received electronic message, added to the electronic message copy, and storing the modified electronic message in the first folder of the account of the respective user comprises storing the electronic message copy, with the supplemental information added to it, in the first folder of the account of the respective user.

In some embodiments, the modified electronic message that includes the supplemental information (e.g., electronic message 410, FIG. 4B) is provided to the respective user (636), at a respective client system (e.g., client 150, FIG. 1), in response to a request for the electronic message, where the respective client system is distinct from the server system, as explained above with reference to operation 314 of method 300, and more specifically with reference to operation 348 of method 340.

Next, in some embodiments, in accordance with a determination that the electronic message fails to satisfy predefined criteria, the server system returns (638) the electronic message from the second folder (e.g., quarantine folder 244, FIG. 2B) to the first folder (e.g., inbox folder 242, FIG. 2B), as explained above with reference to operation 316 of methods 300 and 340. In some embodiments, the electronic message is provided to the respective user (640) in response to a request for the electronic message, as explained above with reference to operation 318 of methods 300 and 340.

In some embodiments, the server system repeats (642) the method with respect to a plurality of electronic messages received at the account of the respective user. Furthermore, in some embodiments, the server system performs method 500 and method 600 on a received electronic message, thereby removing tracked content from the electronic message and adding supplemental information to the electronic message. In some embodiments, method 500 is performed first and method 600 is performed second on a received electronic message, while in other embodiments method 600 is performed first and method 500 is performed second on a received electronic message.

The foregoing description, for purpose of explanation, has been described with reference to specific implementations. However, the illustrative discussions above are not intended to be exhaustive or to limit the claims to the precise forms disclosed. Many modifications and variations are possible in view of the above teachings. The implementations were chosen and described in order to best explain principles of operation and practical applications, to thereby enable others skilled in the art.

What is claimed is:

1. A method of processing electronic messages, comprising:
at a server system:
accessing an electronic message having a message body and received at an account of a respective user;
prior to a first time the respective user views the message body, moving the electronic message from a first folder of the account of the respective user to a second folder;
inspecting the message body to determine whether the message body includes tracking content;
in accordance with a determination that the message body includes tracking content:
generating a modified electronic message having a message body that does not include the tracking content; and
storing the modified electronic message in the first folder of the account of the respective user;
wherein the modified electronic message that does not include the tracking content is provided to the respective user, at a respective client system, in response to a request for the electronic message, wherein the server system is distinct from the respective client system; and
in accordance with a determination that the message body fails to satisfy predefined criteria, returning the electronic message from the second folder to the first folder;
wherein the electronic message is provided to the respective user in response to a request for the electronic message.

2. The method of claim 1, wherein the server system is a server hosting the account of the respective user.

3. The method of claim 1, wherein generating the modified electronic message includes generating an electronic message copy, comprising a copy of the received electronic message that does not include the tracking content, and storing the modified electronic message in the first folder of the account of the respective user comprises storing the electronic message copy in the first folder of the account of the respective user.

4. The method of claim 1, wherein generating the modified electronic message includes adding to the message body of the modified electronic message a substitute object that corresponds to the tracking content in the message body of the electronic message.

5. The method of claim 4, wherein the tracking content in the message body of the electronic message comprises an html tag having a tracking parameter, and the substitute object comprises an html tag that does not include the tracking parameter.

6. The method of claim 4, wherein the tracking content in the message body of the electronic message comprises an html tag that includes a tracking parameter and that references content stored at a third-party server distinct from the server hosting the account of the respective user, and the substitute object comprises an html tag that references a copy of the content stored at the third-party server, wherein the copy of the content is stored at another server distinct from the third-party server.

7. The method of claim 1, wherein the tracking content in the message body of the electronic message comprises tracking content associated with one or more tracking providers included in a set of identified tracking providers.

8. The method of claim 1, wherein the tracking content in the message body of the electronic message comprises tracking content associated with a respective tracking provider, and the method includes:
comparing the tracking content in the message body of the electronic message to a set of identified tracking content associated with the respective tracking provider; and
in accordance with a determination that the set of identified tracking content does not include the tracking content in the message body of the electronic message, updating the set of identified tracking content to include the tracking content in the message body of the electronic message.

9. The method of claim 1, wherein determining that the message body includes tracking content includes identifying the tracking content in the message body of the electronic message in accordance with one or more heuristic patterns, wherein at least one of the heuristic patterns is independent of any specific tracking provider.

10. The method of claim 1, wherein generating the modified electronic message includes adding an indication to the modified electronic message that a modification was made to the electronic message.

11. The method of claim 1, including repeating the method with respect to a plurality of electronic messages received at the account of the respective user.

12. The method of claim 1, wherein the electronic message received at the account of the respective user includes one or more identification parameters, and the method includes accessing the electronic message received at the account of the respective user in accordance with a determination that the one or more identification parameters are not included in a set of approved identification parameters.

13. A server system, comprising:
one or more processors;
memory; and
one or more programs stored in the memory, the one or more programs comprising instructions that when executed by the one or more processors of the server system cause the server system to:
access an electronic message having a message body and received at an account of a respective user;
prior to a first time the respective user views the message body, move the electronic message from a first folder of the account of the respective user to a second folder;
inspect the message body to determine whether the message body includes tracking content;
in accordance with a determination that the message body includes tracking content:
generate a modified electronic message having a message body that does not include the tracking content; and
store the modified electronic message in the first folder of the account of the respective user;
wherein the modified electronic message that does not include the tracking content is provided to the respective user, at a respective client system, in response to a request for the electronic message, wherein the server system is distinct from the respective client system; and
in accordance with a determination that the message body fails to satisfy predefined criteria, return the electronic message from the second folder to the first folder;
wherein the electronic message is provided to the respective user in response to a request for the electronic message.

14. The system of claim 13, wherein the server system is a server hosting the account of the respective user.

15. The system of claim 13, wherein generating the modified electronic message includes generating an electronic message copy, comprising a copy of the received electronic message that does not include the tracking content, and storing the modified electronic message in the first folder of the account of the respective user comprises storing the electronic message copy in the first folder of the account of the respective user.

16. The system of claim 13, wherein generating the modified electronic message includes adding to the message body of the modified electronic message a substitute object that corresponds to the tracking content in the message body of the electronic message.

17. The system of claim 16, wherein the tracking content in the message body of the electronic message comprises an html tag having a tracking parameter, and the substitute object comprises an html tag that does not include the tracking parameter.

18. The system of claim 16, wherein the tracking content in the message body of the electronic message comprises an html tag that includes a tracking parameter and that references content stored at a third-party server distinct from the server hosting the account of the respective user, and the substitute object comprises an html tag that references a copy of the content stored at the third-party server, wherein the copy of the content is stored at another server distinct from the third-party server.

19. The system of claim 13, wherein the tracking content in the message body of the electronic message comprises tracking content associated with one or more tracking providers included in a set of identified tracking providers.

20. The system of claim 13, wherein the tracking content in the message body of the electronic message comprises tracking content associated with a respective tracking provider, the one or more programs further including instructions for:
comparing the tracking content in the message body of the electronic message to a set of identified tracking content associated with the respective tracking provider; and
in accordance with a determination that the set of identified tracking content does not include the tracking content in the message body of the electronic message, updating the set of identified tracking content to include the tracking content in the message body of the electronic message.

21. The system of claim 13, wherein determining that the message body includes tracking content includes identifying the tracking content in the message body of the electronic message in accordance with one or more heuristic patterns, wherein at least one of the heuristic patterns is independent of any specific tracking provider.

22. The system of claim 13, wherein generating the modified electronic message includes adding an indication to the modified electronic message that a modification was made to the electronic message.

23. The system of claim 13, where the one or more programs further include instructions for performing the accessing, moving, inspecting, generating, storing, and returning operations with respect to a plurality of electronic messages received at the account of the respective user.

24. The system of claim 13, wherein the electronic message received at the account of the respective user includes one or more identification parameters, and the one or more programs further include instructions for accessing the electronic message received at the account of the respective user in accordance with a determination that the one or more identification parameters are not included in a set of approved identification parameters.

25. A non-transitory computer readable storage medium storing one or more programs configured for execution by a server system having one or more processors for executing the one or more programs, the one or more programs comprising instructions to:
access an electronic message having a message body and received at an account of a respective user;
prior to a first time the respective user views the message body, move the electronic message from a first folder of the account of the respective user to a second folder;
inspect the message body to determine whether the message body includes tracking content;
in accordance with a determination that the message body includes tracking content:
generate a modified electronic message having a message body that does not include the tracking content; and
store the modified electronic message in the first folder of the account of the respective user;
wherein the modified electronic message that does not include the tracking content is provided to the respective user, at a respective client system, in response to a request for the electronic message; and
in accordance with a determination that the message body fails to satisfy predefined criteria, return the electronic message from the second folder to the first folder;
wherein the electronic message is provided to the respective user in response to a request for the electronic message.
